(19) United States
(12) Patent Application Publication
(10) Pub. No.: US 2003/0036383 A1
(43) Pub. Date: Feb. 20, 2003

(54) Support for massive subscriber profile changes in a telecommunications network

(76) Inventors: Ella Zawislak, Montreal (CA); Amina Sahel, Montreal (CA); Jean-Francois Bergeron, Varennes (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 10/167,955

(22) Filed: Jun. 13, 2002

Related U.S. Application Data
(60) Provisional application No. 60/311,839, filed on Aug. 14, 2001.

(51) Int. Cl. H04Q 7/20

(52) U.S. Cl. 455/433; 455/560

(57) ABSTRACT

A method for storing subscriber service profiles is defined. The method has a step for defining a first table in a home centralized database, where the first table contains identification parameters and each identification parameter is associated to at least one service. The method also has a step for defining a second table in the home centralized database. The second table contains the service profiles and some of the service profiles contain at least one of the identification parameters. A home centralized database and a serving visitor database are also provided.

### PRIORITY STATEMENT UNDER 35 U.S.C. S.119(e) & 37 C.F.R. S.1.78

This non-provisional patent application claims priority based upon the prior U.S. provisional patent application entitled “SUPPORT FOR MASSIVE SUBSCRIBER PROFILE CHANGES IN ANSI-41 E NETWORKS”, application No. 60/311,839, filed Aug. 14, 2001, in the names of Ella ZAWISLAK and Amina SAHEL.

### BACKGROUND OF THE INVENTION

1. Field of the Invention

The present invention relates to a method of storing a plurality of service profiles in a telecommunications network.

2. Description of the Prior Art

In a telecommunications network, an operator is allowed to modify a service profile of a subscriber. A modification in a service profile of a subscriber could be performed based on a subscriber's request or based on a system update. For doing so, the operator has to access the profile of the subscriber. As known today, there are many ways for the operator to access a service profile of a subscriber and one of these ways can be through a graphical user interface. For performing a modification, the operator first locates the profile of the mobile subscriber in a Home Location Register (HLR) and secondly, the operator modifies the service profile of the subscriber.

However, the problem is that this method cannot support modifications in service profiles for groups of subscribers in an efficient way. In the art, performing a modification of a service profile for a group of subscribers is defined as a massive change. As an example, massive changes can be performed for assigning new services to a group of mobile subscribers for a free trial period. Another example is to perform massive changes of service profile data for service upgrades such as in Wireless Intelligent Network (WIN) service profiles.

Nowadays, a method for updating a service profile of a subscriber exists in the American National Standards Institute (ANSI). In that well known standard, a HLR located in a telecommunications network is responsible for storing subscribers' service profiles and a serving Visitor Location Register (VLR), which is located in another network where a subscriber is currently roaming, is responsible for retrieving a copy of the service profile of the subscriber. The existing method for modifying a service profile of a subscriber is to issue from the HLR to the VLR a message (QualificationDirective) containing data for modifying the profile of the subscriber.

However, using that known method does not render possible massive changes. A way to perform this kind of modification with the existing method is to allow the HLR to issue individual messages (QualificationDirective) to the Visitor Location Register (VLR) serving each subscriber, which may result in a very high amount of signaling between the HLR and the serving VLRs.

Therefore, there is a need to improve the way the modification of the service profile of a group of subscribers is handled in a telecommunications network. The present invention provides a solution to this effect.

### SUMMARY OF THE INVENTION

It is therefore one broad object of this invention to provide a method for storing service profiles. The method comprises a step for defining a first table in a home centralized database. The first table contains identification parameters and each of the identification parameters is associated to at least one service. The method also comprises a step for defining a second table in the home centralized database. The second table contains the service profiles and some of the service profiles contain at least one of the identification parameters.

It is another broad object of the present invention to provide a home centralized database for storing subscriber service profiles. The home centralized database comprises a memory for storing a first table that contains identification parameters associated to at least one service and for storing a second table containing subscriber service profiles, which contains at least one of the identification parameters.

It is another broad object of the present invention to provide a visitor database for storing subscriber service profiles. The serving visitor database comprises a memory for storing subscriber service profiles. The subscriber service profiles are registered with the serving visitor database and include at least one identification parameter. Furthermore, the at least one identification parameter is associated to at least one service.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a diagram illustrating a message flow diagram and a schematic of a method for storing service profiles in a telecommunications network of the present invention;

FIG. 2 is a table illustrating identification parameters associated to at least one service, in accordance with the present invention;

FIG. 3 is a table illustrating subscriber service profiles, in accordance with the present invention;

FIG. 4 is a diagram illustrating a variant of the method of the present invention;

FIG. 5 is a block diagram illustrating a home Centralized Database, in accordance with the present invention;

FIG. 6 is a flow chart describing steps for managing groups of services in a home Centralized Database;

FIG. 7 is a block diagram illustrating a serving Visitor Database as defined in the present invention; and

FIG. 8 is a flow chart describing steps for propagating an update of services in a serving Visitor Database.

### DETAILED DESCRIPTION OF THE PREFERRED EMBODIMENTS

The following abbreviations are being used throughout the present application:

CD: Centralized Database;

HLR: Home Local Register;

MS: Mobile Station;

MSC: Mobile Switching Center;

OMC: Operations and Maintenance Center;

SC: Service Center;

SN: Switching Node;

VD: Visitor Database; and

VLR: Visitor Location Register.

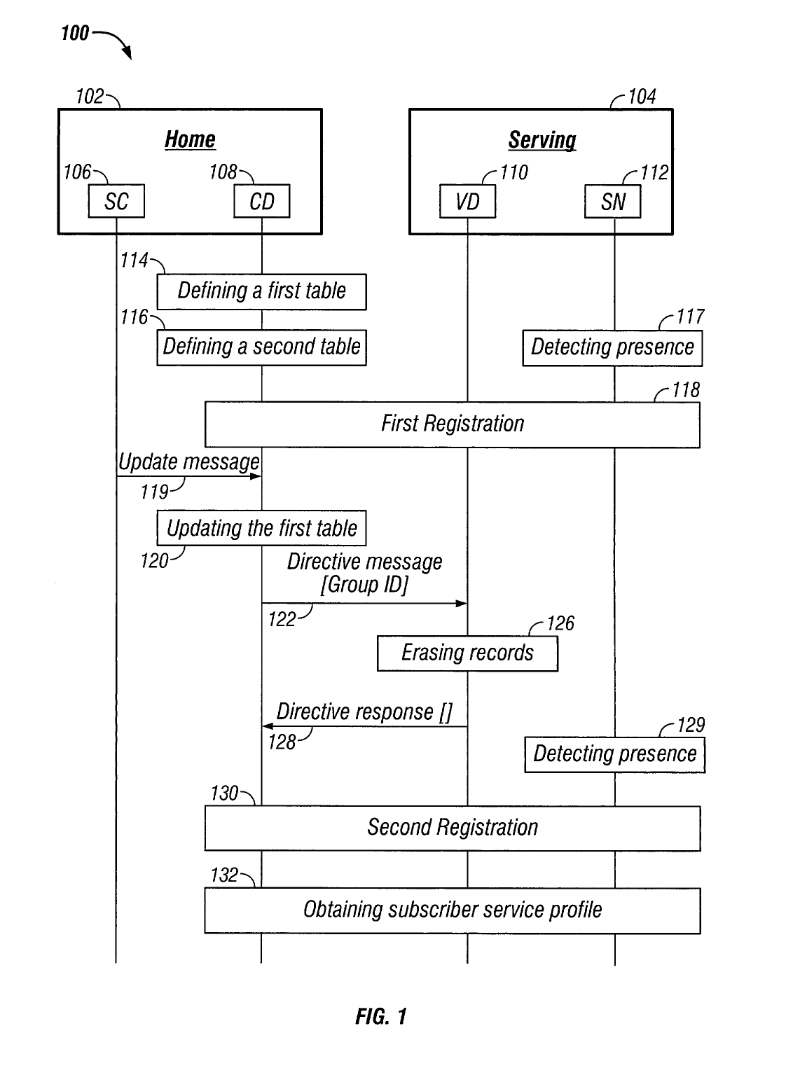

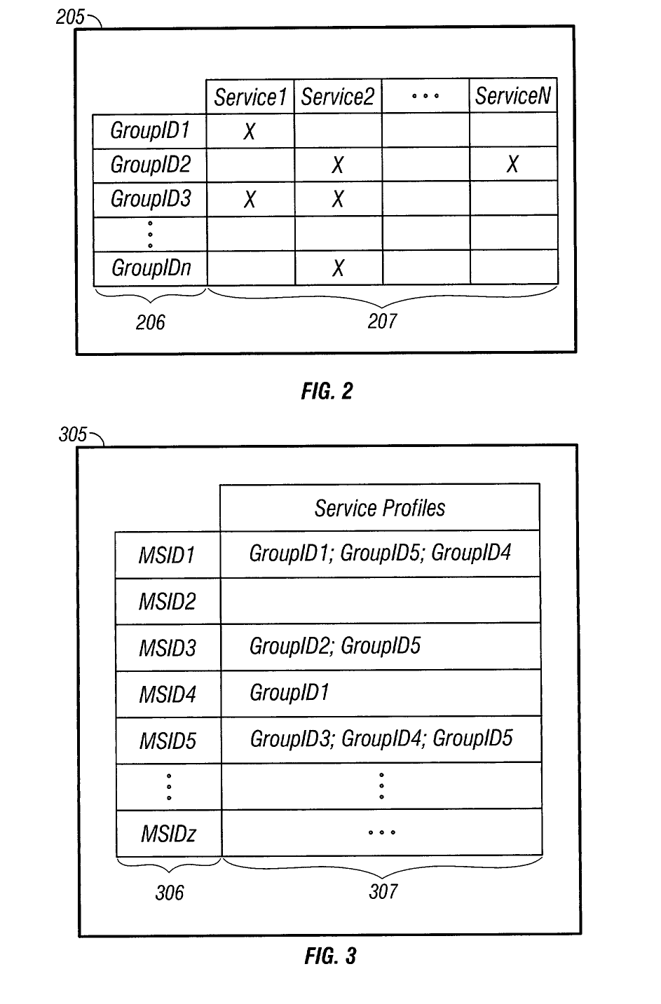

Reference is now made to FIG. 1, which is a diagram that illustrates a message flow diagram and a schematic of a method of storing service profiles in a telecommunications network 100, to FIG. 2 that illustrates a table that contains identification parameters associated to at least one service, and further to FIG. 3 that illustrates a table that contains subscriber service profiles. The telecommunications network 100 comprises a Home network 102 and a Serving network 104. It is well known in the telecommunications standards (e.g. ANSI-41 or 3GPP) that a Mobile Station (MS) or any mobile equipment of a subscriber is registered in a Home network. If the MS is located in the Home network 102, the Home network 102 is called the serving network of the MS. However, the MS can roam in different networks. Therefore, a network where the MS roams becomes the serving network of the MS. It is also well known that the MS of the subscriber gives him access to services that he has subscribed to in his home network. Afterwards, the services are stored in his subscriber service profile for further uses.

In FIG. 1, the Home network 102 comprises a Service Center (SC) 106 for operating and managing services and network elements of the Home network 102. The SC 106 manages network elements such as a Centralized Database (CD) 108, which is a permanent database for storing subscriber service profiles in the Home network 102. The Serving network 104 comprises a Visitor Database (VD) 110 as a temporary database for storing subscriber service profiles of roaming and non-roaming subscribers, and a Switching Node (SN) 112 for controlling the switching and signaling between a MS, the CD 108 and the VD 110. Furthermore, similar nodes as the SC 106, CD 108, VD 110 and SN 112 are used in 2G networks such as in a Time Division Multiple Access (TDMA) network or a Code Division Multiple Access (CDMA), 2.5G networks such as a General Packet Radio Service (GPRS), or 3G networks such as a Universal Mobile Telecommunications System (UMTS). In these particular networks (2G, 2.5G, and 3G), the similar nodes for the SC 106, CD 108, VD 110 and SN 112 can respectively be an Operations and Maintenance Center (OMC), a Home Location Register (HLR), a Visitor Location Register (VLR), and a Mobile Switching Center (MSC). More particularly, in 3G networks a MSC or a MSCNLR could be coupled with another network element such as a Serving GPRS Support Node (SGSN) for routing of packet data. This coupling in 3G networks gives a similar functionality of the VD 110 and the SN 112 of the invention. Therefore the invention is not only limited to 2G, 2.5G or 3G networks.

At step 114, the home CD 108 defines a first table 205 (FIG. 2) that contains identification parameters 206, also called groups of services, associated to at least one service 207. In FIG. 2, the first table 205 is represented with a column 206 that contains group of services (Group 1 to Group n) and at least one column 207 for services (Service1 to ServiceN). Since, each column 207 is assigned to one service, the table 205 allows associating services in column 206 to one or many groups. At step 116, the CD 108 defines a second table 305 (FIG. 3) that contains subscriber service profiles. The second table 305 is defined with a first column 306 of Mobile Station identification parameters (MSID1 to MSIDz) for identifying subscribers, and by a second column 307 of Service profiles.

In a way to provide communication service to a subscriber of a Mobile Station (MS) (not shown) that is identified by a MSID, the Home network 102 has to first locate the MS and therefore has to determine in which serving network the MS is currently roaming. At step 117, the serving SN 112 detects that the MS is roaming in its service area. This detection is based on an autonomous registration, a call origination, a call termination, a service order or any other similar mechanism well known in telecommunication industry. Following this detection, the serving SN 112, the serving VD 110, and the home CD 108 perform a first registration 118 of the MS of the roaming subscriber. The first registration 118 is performed in a regular fashion, and as described in many telecommunications standards. The steps inherent to the first registration 118 are not shown in the Figures, but are briefly described hereinafter for facilitating the understanding of the reader. However, it should be noted that the present invention is not limited to the described first registration, but rather includes any other means for performing first registration as well known in the art.

During the first registration 118, the home CD 108 receives from the serving VD 110 the MSID corresponding to the subscriber. Upon reception of the MSID, the home CD 108 validates the MSID and transmits the corresponding subscriber service profile to the serving VD 110. Afterwards, the serving VD 110 transfers the received subscriber service profile to the serving SN 112 for allowing completion of the registration of the subscriber with the Serving network 104. The subscriber service profile is stored temporarily in the VD 110 for a certain period of time. This period is variable and depends on whether or not the MS is roaming in a different area or if communication services have been updated in his Home network 102.

The subscriber service profiles can be updated by an operator or a service provider, or by any person that has the right to modify subscriber services in the telecommunications network. The update of subscriber service profiles is sometimes based on an event such as an addition of new services for a free trial period, or service upgrades such as in a Wireless Intelligent Network (WIN). Many other reasons, not enumerated here, can also cause update of subscriber service profiles. Therefore, whenever one or more services are modified in the Home network 102, a message (Update message 119) is sent from the home SC 106 to the home CD 108. The Update message 119 contains a SCID parameter (not shown) for authenticating the home SC 106 and data for updating the service or services of one or many Groups 206 in the first table 205 of the home CD 108. Upon reception of the Update message 119, the home CD 108 authenticates the home SC 106 and updates one or many groups of services 206 by modifying some of the services 207 in the first table 205 (step 120). After updating the first table 205, the home CD 108 informs at least one serving VD 110 with a Directive message 122. The Directive message 122 contains at least one of the updated GroupIDs 206 and a SNID parameter for identifying the serving SN 112. Upon reception of the Directive message 122, the VD 110 erases all subscriber service profiles, which contain the updated GroupIDs (step 126). Subsequently to that operation, the serving VD 110 returns an empty Directive response message 128 to the home CD 108 for confirming the receipt of the Directive message 122. Because of the updated GroupIDs, the subscriber service profiles stored in the VD 110 that included one or many of the updated GroupIDs are rendered unreliable. Then, should the subscribers roaming in the Serving network 104, and for which their subscriber profile was erased in step 126 wish to obtain communication service again in the Serving network 104, a second registration is required. The method also allows retrieving the subscriber service profile from the CD 108 after a second registration.

More specifically, for doing so, in the method at step 129, the serving SN 112 detects that the MS of the subscriber is roaming in its service area. Such as for the first registration, the second registration is performed by the serving SN 112, the serving VD 110, and the home CD 108 upon an autonomous registration, a call origination, a call termination, a service order or another similar mechanism.

Following this detection, the serving SN 112, the serving VD 110, and the home CD 108 perform the second registration, step 130. During the second registration 130, the home CD 108 receives from the serving VD 110 the MSID (not shown) of the MS. Upon reception of the MSID, the home CD 108 validates the MSID and transmits the subscriber service profile to the serving VD 110 (step 132). Afterwards, the serving VD 110 transfers the subscriber service profile to the serving SN 112 for providing communication service to the roaming subscriber. The subscriber service profile is stored temporarily in the VD 110 for a certain period of time. This period is variable and depends on whether or not the MS is roaming in a different area or if communication services have been updated in his Home network 102.

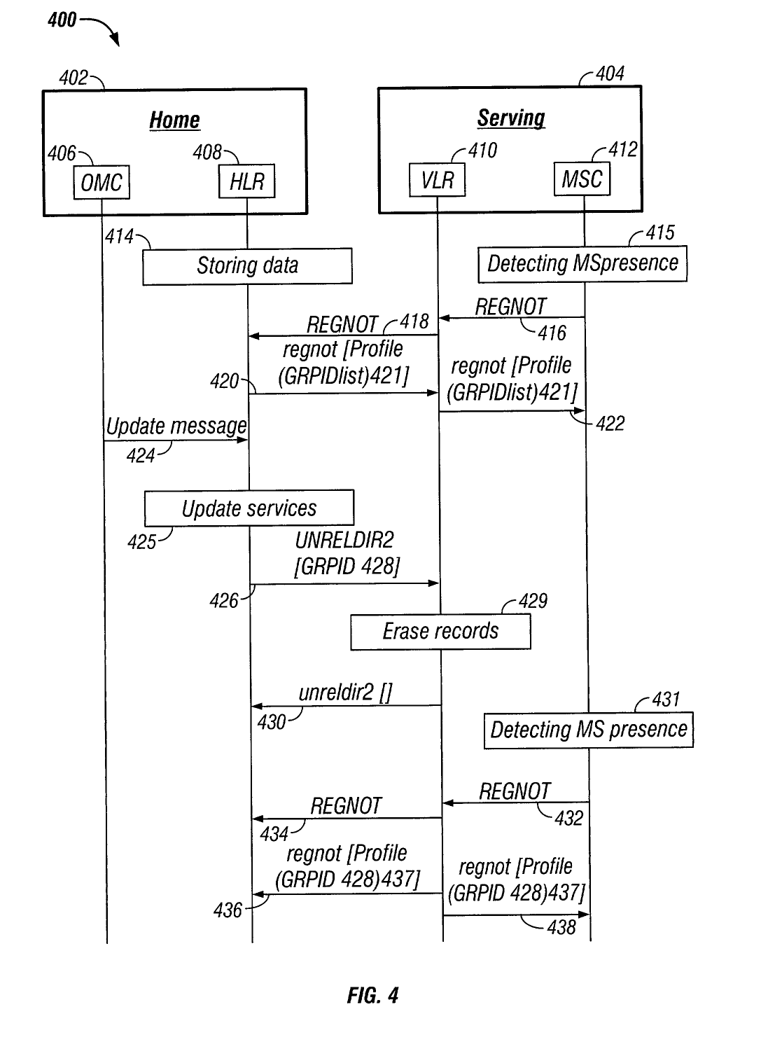

Reference is now made to FIG. 4, which is a diagram illustrating a variant of the method of the invention. The telecommunications network 400 comprises a Home network 402 and a Serving network 404. The Home network 402 comprises an Operations and Maintenance Center (OMC) 406 for operating and managing services and network elements of the Home network 402. The OMC 406 manages network elements such as a Home Location Register (HLR) 408, which is a permanent database for storing subscriber service profiles in the Home network 402. The Serving network 404 comprises a Visitor Location Register (VLR) 410 as a temporary database for storing subscriber service profiles of roaming and non-roaming subscribers and a Mobile Switching Center (MSC) 412 for controlling the switching and signaling between a MS, the HLR 408 and the VLR 410. At step 414, the HLR 408 stores data regarding services provided to a plurality of subscribers in the telecommunications network 400 and as shown on FIGS. 2 and 3 and previously described.

In a way to provide communication service to a subscriber of a Mobile Station (MS) that is identified by a MSID, the Home network 402 has to first locate the subscriber and therefore has to determine in which serving network the subscriber is roaming. At step 415, the MSC 412 detects the presence of the MS (not shown) of the subscriber in its service area. This detection can be based for example, on an autonomous registration, a call origination, a call termination, a service order or any other mechanism. Following this detection, the serving MSC 412 sends a RegistrationNotification message (REGNOT) 416 to the serving VLR 410. The message REGNOT 416 includes an IDInfo parameter (not shown). The IDInfo contains information regarding the identity of the MS and the identity of the MSC 412. The REGNOT 416 may also include the location of the subscriber. After receiving the REGNOT 416, the serving VLR 410 verifies that the MS has previously registered with an MSC in its domain by using the information in the IDInfo parameter. After the verification and confirmation of no previous registration, the VLR 410 forwards the REGNOT 416 to the HLR 408 in a REGNOT 418. Upon reception of this message, the HLR 408 validates the identity of the MS and the MSC 412 and returns data to the VLR 410 in a regnot 420. The regnot 420 includes a subscriber service profile (Profile 421) and a MSCID parameter (not shown) for identifying the serving MSC 412. Furthermore, the subscriber service profile 421 may also include a GRPIDLIST parameter (in message 421). The GRPIDLIST parameter is a list of GRPIDs contained in the subscriber service profiles stored in the HLR 408. Afterwards, the first registration is completed when the serving VLR 410 finally replies to the REGNOT 416 with a regnot 422 to the serving MSC 412. The regnot 422 includes the subscriber service profile 421.

Whenever one or more services are updated in the Home network 402, an Update message 424 is sent from the home OMC 406 to the HLR 408. The Update message 424 contains an OMCID (not shown) for authenticating the home OMC 406 and data for updating the subscriber service profiles in the HLR 408. Upon reception of the Update message 424, the HLR 408 authenticates the OMC 406 and updates the subscriber service profiles (step 425). After updating the subscriber service profiles, the HLR 408 informs all its associated VLRs with an UnreliableRoamerDataDirective2 message (UNRELDIR2) 426. In FIG. 4, the HLR 408 informs the serving VLR 410 with the UNRELDIR2 message 426. The UNRELDIR2 426 contains a MSCID [HLR] parameter (not shown) for identifying the MSC 112, a HLR's Sender Identification Number (SENDERIN parameter) (not shown) for identifying the HLR 408 and at least one of the group of services identification parameters (GRPID 428) of the updated group of services updated in the HLR 408. Upon reception of the UNRELDIR2 426, the VLR 410 erases subscriber service profiles that contain the GRPID 428 (step 429). Afterwards, the serving VLR 410 confirms the reception of the UNRELDIR2 426 by returning an empty unreldir2 430 to the HLR 408. Therefore, all subscriber service profiles stored in the serving VLR 410, which contain the GRPID 428 are rendered unreliable. Then, for providing communication services to the roaming subscriber, the telecommunications network 400 has to retrieve a subscriber service profile. For doing so, the Serving network 404 retrieves the subscriber service profile for the subscriber after a second registration.

Such as in the first registration, the second registration of the subscriber is performed upon a presence detection of his MS by its serving MSC 412. This detection can be based for example, on an autonomous registration, a call origination, a call termination, a service order or any other similar mechanism. Following this detection, the serving MSC 412 sends a REGNOT message 432 to the one or many VLRs for locating a serving VLR. In FIG. 4, the VLR 410 is acting as the serving VLR. The REGNOT 432 message includes an IDInfo parameter (not shown). The IDInfo contains information regarding the identity of the MS and the identity of the MSC 412. The REGNOT 432 may also include the location of the subscriber. After receiving the REGNOT 432, the serving VLR 410 verifies that the MS has previously registered with an MSC in its domain by using the information in the IDInfo parameter. After the verification, the VLR 410 forwards the REGNOT 432 to the HLR 408 in a REGNOT 434. Upon reception of this message the HLR validates the identity of the MS and the MSC 412 and returns data in a regnot 436 to the VLR 410. The regnot 436 includes a subscriber service profile (Profile 437) and a MSCID parameter (not shown) for identifying the MSC. The subscriber service profile 437 may also include a GRPIDLIST parameter (not shown). Afterwards, the second registration is completed when the serving VLR 410 finally replies to the REGNOT 432 with a regnot 438 that includes the subscriber service profile 437 to the serving MSC 412.

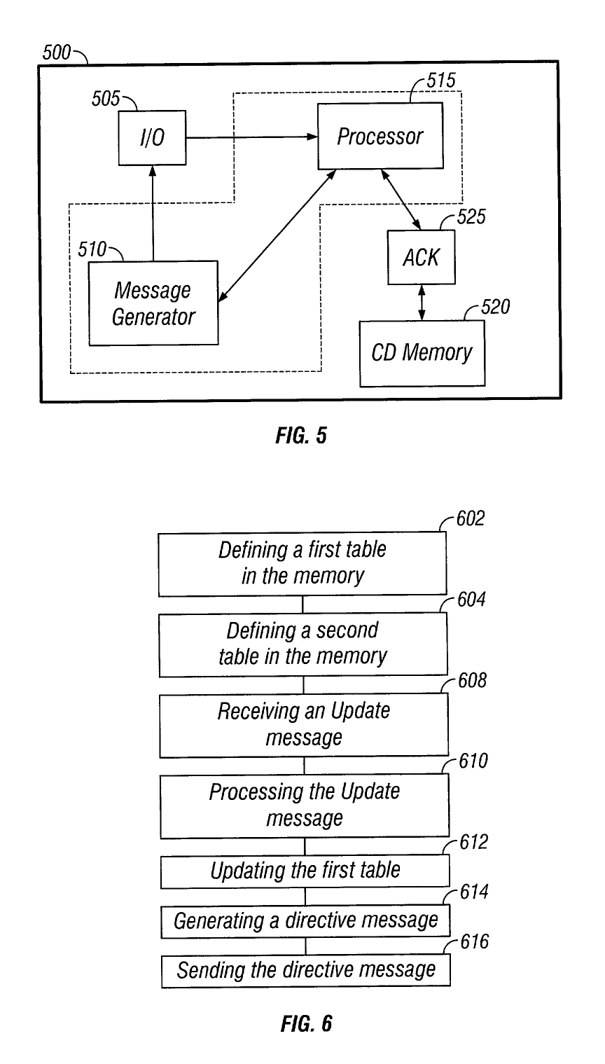

Reference is now made to FIG. 5, which is a block diagram that illustrates a home CD 500, and further to FIG. 6 that is a flow chart that describes the steps for managing groups of services in the home CD 500. The home CD 500 comprises an I/O (Input/Output) Unit 505 that receives and sends messages, a Message Generator 510 that generates messages and a Processor 515 that processes incoming and outgoing messages. The home CD 500 further comprises a CD Memory 520 that stores data and an ACK (Acknowledge functionality) 525 that provides access to the CD Memory 520.

As an example, the CD 500 can be represented by a HLR in 2G, 2.5G or 3G networks. In that case, the I/O (Input/Output) Unit 505 can be a HLR's receiver/transceiver, the Message Generator 510 and the Processor 515 can be coupled and act as a HLR's Central Processing Unit (CPU), the CD Memory 520 can be a HLR's central memory and the ACK 525 can be a memory controller that provides access to the HLR's central memory.

At step 602, the home CD 500 defines a first table that contains identification parameters associated to at least one service and stores the first table in the CD Memory 520. Subsequently, at step 604, the home CD 500 defines a second table containing service profiles that includes at least one of the identification parameters. In a similar manner, the CD 500 stores the second table in the CD Memory 520. In a telecommunications network, it is common to update the service profile of a subscriber. However, prior to this update a home Service Center, which stores data regarding services provided to the subscriber, sends a message to the home CD 500 for updating one or more services. The message sent from the Service Center is similar to the Update message 119, which has been previously described in the description of FIG. 1. At step 608, the home CD 500 receives an Update message from the home Service Center at the I/O 505. The home CD 500 then processes the message (step 610), accesses the CD Memory 520, and updates the first table (step 612). Subsequently to this update, the home CD 500 informs all Serving networks (serving VDs) that a change in at least one group of services has occurred. For doing so, the home CD 500 generates, at step 614, a Directive message, which is similar to the Directive message 122 previously described in the description of FIG. 1. The Directive message 122 includes specified data and at least one of the group identification parameters that identifies the group of services where a change has occurred.

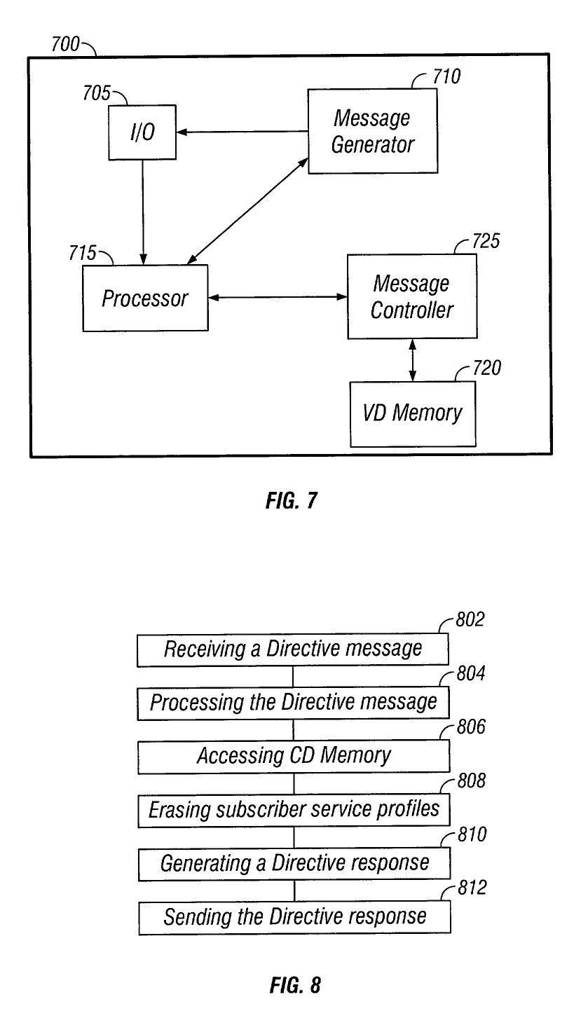

Reference is now made to FIG. 7, which is a block diagram that illustrates a serving VD 700, and further to FIG. 8 that is a flow chart that describes the steps for propagating an update of services in the serving VD 700. The serving VD 700 comprises an I/O (Input/Output) Unit 705 that receives and sends messages, a Message Generator 710 that generates messages, a Processor 715 that processes incoming and outgoing messages, a VD Memory 720 that stores data, and a Memory Controller 725 that provides access to the VD Memory 720.

As an example, the VD 700 can be represented by a VLR in 2G, 2.5G or 3G networks. In that case, the I/O (Input/Output) Unit 705 can be a VLR's receiver/transceiver, the Message Generator 710 and the Processor 715 can be coupled and be used as a VLR's Central Processing Unit (CPU), the VD Memory 720 can be a VLR's memory and the Memory Controller 725 can be a memory controller that provides access to the VLR's memory.

At step 802, the VD 700 receives at the I/O 705 a Directive message from a home CD. The Directive message is similar to the Directive message 122 described in the description of FIG. 1 and includes at least one group identification parameter (GroupID). Following this, the VD 700 processes the message (step 804), accesses the VD Memory 720 (step 806), and erases all records associated to the GroupID. Afterwards, the VD 700 generates a Directive response message (step 810) and sends the Directive response message to the home CD for acknowledging receipt of the Directive message (step 812).

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for storing subscriber service profiles, the method comprising the steps of:
defining a first table in a home centralized database, the first table containing identification parameters, each of the identification parameters being associated to at least one service; and
defining a second table in the home centralized database, the second table containing subscriber service profiles, and some of the subscriber service profiles containing at least one of the identification parameters.

2. The method for storing subscriber service profiles of claim 1, the method further comprising a step of updating in the first table the at least one service associated with at least one of the identification parameters, whereby updating the service profiles.

3. The method for storing subscriber service profiles of claim 1, the method further comprising steps of:
performing a first registration of a subscriber;
sending an update message from a home service center to the home centralized database; and
receiving the update message at the home centralized database.

4. The method for storing subscriber service profiles of claim 3, the method further comprising steps of:
generating at the home centralized database a directive message including at least one of the identification parameters corresponding to the updated services;
sending the directive message from the home centralized database to at least one serving visitor database;
receiving the directive message at the at least one serving visitor database;
erasing at the at least one serving visitor database records including the at least one of the identification parameters included in the directive message;
sending a directive response message from the at least one serving visitor database to the home centralized database;
receiving the directive response message from the at least one serving visitor database to the home centralized database;
performing a second registration of the subscriber; and
obtaining from the home centralized database by the at least one serving visitor database the subscriber service profile for the at least one subscriber.

5. A home centralized database for storing subscriber service profiles, the home centralized database comprising:
a memory for storing a first table containing identification parameters associated to at least one service and for storing a second table containing subscriber service profiles, the subscriber service profiles containing at least one of the identification parameters.

6. The home centralized database of claim 5, the home centralized database further comprising:
an acknowledge functionality for accessing the memory.

7. The home centralized database of claim 5, the home centralized database further comprising:
a message generator for generating a directive message including the at least one of the identification parameters.

8. The home centralized database of claim 5, the home centralized database further comprising:
a processor for processing a directive message including the at least one of the identification parameters and for processing directive response message received from at least one serving visitor database.

9. The home centralized database of claim 5, the home centralized database further comprising:
an input/output unit for sending a directive message to at least one serving visitor database and for receiving a directive response message from the at least one serving visitor database.

10. A serving visitor database for storing subscriber service profiles, the serving visitor database comprising:
a memory for storing subscriber service profiles of subscribers currently being registered with the serving visitor database, some of the subscriber service profiles including at least one identification parameter, the at least one identification parameter being associated to at least one service.

11. The serving visitor database of claim 10, the serving visitor database further comprising:
a memory controller that accesses the memory and erases the records including the at least one identification parameter included in a directive message.

12. The serving visitor database of claim 10, the serving visitor database further comprising:
an input/output unit for receiving a directive message including the identification parameter associated to at least one service from a home centralized database and for sending a directive response message to the home centralized database.

13. The serving visitor database of claim 10, the serving visitor database further comprising:
a processor for processing a directive message received at an input/output unit.

14. The serving visitor database of claim 10, the serving visitor database further comprising:
a message generator for generating a directive response message.
